(19) United States
(12) Patent Application Publication
(10) Pub. No.: US 2005/0131793 A1
(43) Pub. Date: Jun. 16, 2005

(54) Automated tax cost basis

(76) Inventor: Curtis Hill, Los Angeles, CA (US)

Correspondence Address: John P. Mulgrew, 11012 Langton Arms Ct., Oakton, VA, 22124, US

(21) Appl. No.: 10/735,699

(22) Filed: Dec. 16, 2003

(51) Int. Cl. G06F 17/60

(52) U.S. Cl. 705/36

(57) ABSTRACT

The invention discloses the use of a method for automatically accounting for stock events that may effect an investor's portfolio. The method involves providing a database that can be used to describe how an investors investments may have changed as a result of stock events that occurred during a time period when an investor held a stock.

### FIELD OF THE INVENTION

The present invention generally relates to an automated method for determining cost basis for securities for use in tax accounting by utilizing a historical database of stock events.

### BACKGROUND OF THE INVENTION

Over time, an investor may purchase or sell stock in a particular company many times, and the stock may undergo a variety of other stock events such as splits, mergers, spin-offs and the like. As the number of stock events and transactions increases, it becomes increasingly more difficult to account for them. Furthermore, there are several accepted accounting methods for tracking stock events and transactions that result in different tax and cost basis consequences when a stock is sold. As a result, CPAs, tax preparers, stockbrokers and other financial advisors often are asked to explain, research, or calculate tax related issues concerning securities purchased, sold, or held by their clients.

For instance, the sale of stock in any given year may require the investor to pay taxes for short-term or long-term gains. As a result, investors need to know the cost basis of their stock in order to properly account for trading or other tax events during the year.

The cost basis of a stock is the price per share paid for each stock held by the investor. Thus, an investor who purchases 10 shares of stock for 100 dollars has an initial cost basis of 10 dollars per share. If the stock subsequently undergoes a 2-for-1 split, thereby resulting in the investor having 20 shares of the stock, the cost basis for those shares would be 5 dollars per share. If the investor purchased additional shares of the stock at a later time, those shares would have their own cost basis that could be separately tracked and adjusted in response to stock events.

As an example, an investor may have purchased stock in Cisco during the past 13 years since the stock became publicly traded. During this period, Cisco has split 9 times. With each split affecting the cost basis of the previously purchased stock, determining the cost basis can become very complex. The difficulty in determining cost basis of the Cisco stock currently held becomes even greater if the investor also has sold some of the stock at different times, such as between other splits or stock events that affect basis.

Other stock events in addition to the split of a stock may further complicate the determination of cost basis of a block of stock. For instance, if a company spins-off part of its business under a separate company, it may issue stock under the new company in a manner that affects the cost basis of the original stock held by the investor. After the spin-off, the investor must then determine the cost basis of not only the originally held stock, but also the cost basis of the newly issued stock in the spun-off company. Likewise, a company may merge with another company, such as by exchanging an amount of stock for each share of the other stock. These stock events can be make it very difficult to determine the basis of a stock.

A classic example of this difficulty is the case of AT&T, which is a widely held stock that not only has split several times, but also was subjected to a divestiture of 7 Regional Bell companies in 1984. Thus, a person holding shares of AT&T at the time of the divestiture became a shareholder in each of the Regional Bells. Since then, the Regional Bell companies have split many times, and many also have had spin-offs, mergers, and other stock events affecting cost basis. Moreover, AT&T has spun-off four other stocks since the divestiture of the Regional Bells: Lucent, NCR Corp., AT&T Wireless, and Comcast. Most of these stocks also have undergone splits, spin-offs, mergers and other stock events affecting their cost basis. In all, a person who held AT&T stock in 1983 until today would have passed through 30 different entities having 30 separate tax bases, and presently would have 13 surviving entities today with 20 different tax bases. The cost basis of each stock would need to be determined if they were sold today in order to understand the tax consequences of the sale.

Tax laws also may allow the basis of a stock to be adjusted, or “stepped up”, in response to certain events, such as when a stock is inherited after the death of the stockholder. Moreover, tax laws may provide for the determination of the new basis of the stock to be based on the market value of the stock either at the time of death or at an alternate date, such as 6 months afterwards.

Differences in accepted accounting methods also make the determination of cost basis even more difficult when there have been partial sales of stock. As mentioned above, the cost basis of stocks acquired or purchased at one time may differ from the cost basis of other stocks acquired or purchased at a different time. As the stock is sold, the investor may use a variety of different accounting methods to determine the tax consequences of the sale of stock.

Some examples of different accounting methods include FIFO, LIFO, HIFO, HIFO-Long, Average basis, or hand matching. FIFO, or First In First Out, matches each sale of stock to the earliest purchase or acquisition. This method is frequently used by investors and the IRS. In a steadily increasing market, however, this method generally results in identifying the shares of stock having the lowest cost basis as the stocks that are sold first. In these circumstances, the result is that the sale is accounted as having a higher gain, and thus higher taxes may be due.

LIFO, or Last In First Out, matches each sale of stock with the most recent acquisitions or purchases. In a steadily increasing market, this method generally results in identifying the shares of stock having higher cost basis as the stocks that are sold first. One potential disadvantage of this method is that it may result in the investor having short-term gains, which may be taxed at higher rates than long-term gains. Additionally, for stocks that fluctuate in price rather than steadily increasing, this approach also may not identify the shares of stock having the highest cost basis.

HIFO, or Highest In First Out, matches the shares of stock having the highest cost basis with the earliest sales of stock. This approach generally results in the lowest gains or the highest losses, but once again there are no provisions for minimizing ordinary tax rates for short-term gains.

HIFO-Long, or Highest In First Out with longer term gain preference, matches the blocks of stock having the highest cost basis that were also purchased or acquired at least 12 months before the sale of stock. This approach generally reports the lowest gains or the highest losses while minimizing ordinary tax rate gains.

Two more accounting methods used by investors involve using the average cost basis of all blocks of stocks acquired or purchased as the cost basis for the sale of stock, or simply matching blocks of stock to each sale on an ad hoc basis.

On occasion, investors may change accounting methods in order to lower the tax consequences of the sale of stock. Two examples of this are FIFO/HIFO and FIFO/HIFO-Long. In each of these examples, the investor initially accounts for the sale of stock on a FIFO basis, but subsequently converts to a more optimum method such as HIFO or HIFO-Long. Other conversions from one method to another are likewise possible, such as Average/HIFO or Average/HIFO-Long.

In sum, there are many complications surrounding the steps taken to properly determine the cost basis of a stock. While splits information is widely available, currently there are limited resources available for identifying and accounting for other stock events such as spin-offs or mergers. For instance, many resources are available for automatically obtaining historical price information for a stock that also accounts for stock splits. As a result, investors and their advisors often are required to manually calculate cost basis of a stock. Thus, there remains a need for a way to more easily determine cost basis of a stock, even when there have been complex stock events or multiple buy and sell transactions by the investor.

Stock certificates are another example of how limited information about a stock can require complex manual research and time-consuming calculations. A person who has an old stock certificate may not easily be able to determine what stocks have resulted from it (e.g., splits, mergers, spin-offs, etc.) or what its value is today. Typically, such research on an old stock certificate must be done manually. This process is not only tedious and time-consuming, but may be done incorrectly as the complexity of stock events increases. Thus, it would be beneficial to be able to quickly and automatically determine the identity and quantity of stocks that result from a stock certificate without resorting to manual research.

Additionally, an investor may hold a stock that they received as a result of a stock event rather than by actively purchasing or acquiring it. As mentioned above, an AT&T shareholder may also be a shareholder in many other stocks that the investor never actively purchased. In some cases, the stock may have been obtained from more than one stock event, such as by a divestiture and subsequent series of mergers with different companies. Shares of SBC, for instance, may have originated from a name change of Southwestern Bell, or from mergers with Pacific Telesis, Southern New England Tel, or Ameritech.

Because the investor did not actively purchase or acquire the stock, the investor may forget where, when, or how it was obtained. Currently, researching where an investor may have obtained a stock must be done manually, which can take considerable time and may be performed incorrectly if the possible origins of the stock are complex.

Yet another example of where current limited resources require CPAs, attorneys, and other professionals to conduct manual research is in the evaluation of estate portfolios. Under current tax law, the valuation of an estate may be determined either at the decedent's actual date of death or at an alternate date. In particular, under present tax law the alternate date is six months after the actual date of death. Often, monthly or quarterly statements of the decedent's portfolio alone fall short of providing date of death and alternate date information. Additionally, some of stocks of the estate may have been held in stock certificate form rather than through a broker, and therefore would need to be manually researched and updated as described above. Also, because the valuation involves a lifetime of investments, the number of transactions and stock events to account for can be considerably large.

In the past, estate attorneys and CPA's would manually calculate which date provides the greatest tax advantage for the heirs of the estate. Not surprisingly, accounting for the many factors described above can significantly delay the valuation process. Additionally, manual calculation of complex transactions and stock events is subject to human error. For these reasons, it would be beneficial to be able to quickly and accurately compare the basis or value of stocks based on at least two different dates.

While many companies, investment-oriented websites, and brokers may maintain web sites for shareholders to track the growth and worth of stock investments over time, these websites do not automatically determine which stock events affect the user. For instance, company supported investor relations sites often report only limited stock events over a brief duration. Further, these sites do not automatically determine which stock events affect the user.

### SUMMARY OF THE INVENTION

The present invention has several features and advantages that may be combined and utilized in several different ways in order to automatically analyze and answer selected questions about an investor's portfolio. In one embodiment, the present invention utilizes a privately maintained database of stock events (splits, spin-off, mergers, purchases, sales, etc.) to analyze cost basis of at least one stock held by an investor.

The database may include stock events for a wide variety of companies. For instance, in one embodiment the database comprises stock event information for about 100 or more companies. In yet another embodiment the database comprises stock event information for about 250 or more companies, and in yet another embodiment the database comprises stock event information for about 500 or more companies.

The database also may comprise stock event information covering different lengths of time. For example, the database may comprise stock event information covering at least about the past 10 years for the stocks included in the database. In another embodiment, the database covers stock event information for about 30 years or more. In a preferred embodiment, the database comprises stock event information for about 50 years or more for the stocks included in the database.

In another embodiment, about 80 percent or more of the stocks included in the database comprise complete stock event information beginning from the first issuance of the publicly traded stock. In another embodiment, about 90 percent or more of the stocks in the data base have information regarding all stock events for the stocks. In yet another embodiment stock event information for each stock in the data base is complete for the entire time the stocks have been publicly traded.

Preferably, the present invention may be able to receive and automatically analyze complex stock transactions and stock events. In one embodiment, for example, the present invention can automatically analyze multiple buy and sell transactions of an investor's stock as well as automatically identify and account for stock events that take place during the period in which the investor holds the stock.

This information may then be used to automatically determine the cost basis of stocks held by the investor that are related to transactions and stock events being analyzed. For instance, an investor who owns AT&T stock may also own shares of Southwestern Bell as a result of a stock event. In a preferred embodiment of the present invention, the investor's cost basis for the Southwestern Bell stock may be automatically determined in addition to automatically determining the cost basis of AT&T stock. The investor also may have purchased or sold Southwestern Bell stock before the company became SBC. These purchases or sales of Southwestern Bell stock may effect the cost basis of SBC that the investor got from AT&T. Similarly, an investor holding AT&T may have sold some lucent stock after a spin-off, which in turn may effect how much Avaya stock the investor received and its basis. Thus, in one embodiment the present invention may be used to automatically determine which stock events from the database effect tax cost basis, and preferably also automatically calculates the effect of the stock event on the investor's stock holdings.

Another feature of the present invention found in many embodiments is the ability to automatically determine when other related stocks should be examined for customer transactions. In many of these embodiments, systems and methods of the present invention can automatically identify possible origins of a stock in an investor's portfolio that the investor did not actively acquire or purchase.

Another embodiment of the invention allows an investor or advisor to follow cost basis of multiple stocks as additional shares are added to the investor's portfolio as a result of stock events.

In another embodiment, the present invention is capable of applying a variety of different accounting methods that may be selected by the user. For instance, one embodiment of the present invention allows a user to selectively apply accounting methods comprising at least FIFO and LIFO accounting methods. In another embodiment, the invention allows selection of at least FIFO and HIFO accounting methods. Yet another embodiment of the present invention allows a user to manually associate sales of stock with blocks of stock. In a preferred embodiment, the accounting methods available to the user includes at least FIFO, LIFO, HIFO, and HIFO-Long accounting methods.

In one embodiment, the present invention is capable of automatically performing calculations for estates. For example, one embodiment of the present invention allows a user to automatically perform and compare calculations for date of death and alternate date portfolio evaluations.

### BRIEF DESCRIPTION OF THE FIGURES

FIG. 1 is a flow chart illustrating one embodiment of the invention that automatically determines cost basis of stocks according to a selected accounting method;

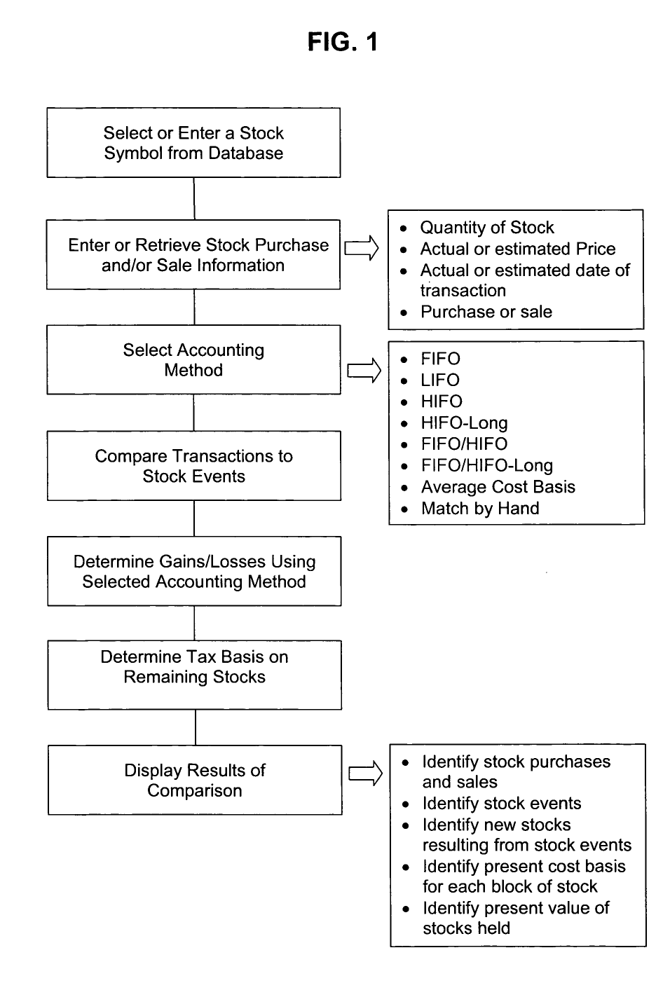

FIG. 2 is a flow chart illustrating one embodiment of the invention where the value of a stock certificate is automatically determined:

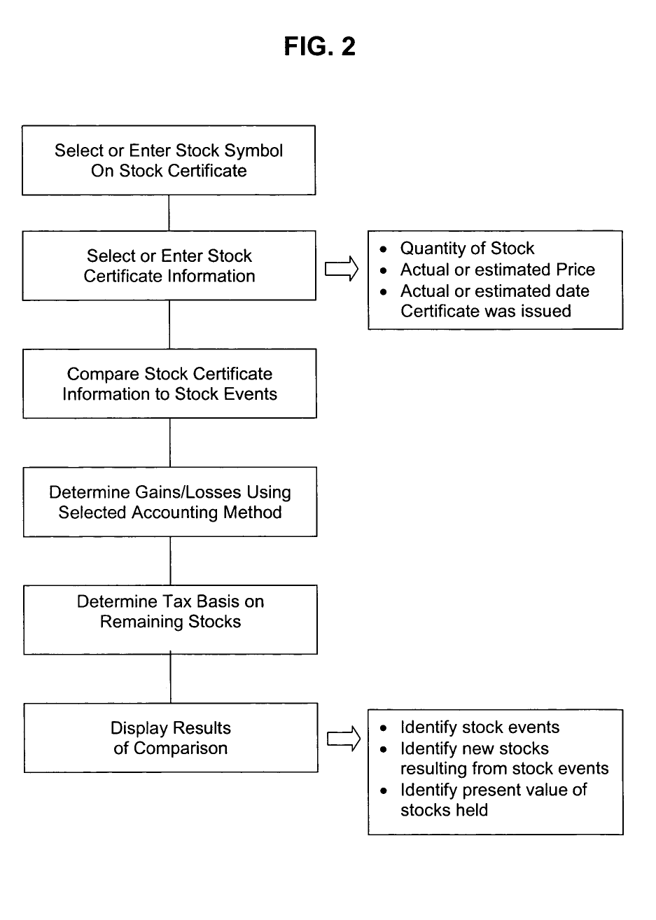

FIG. 3 is a flow chart of yet another embodiment of the invention showing how the present invention may be used to automatically identify where a stock owned by an investor may have originated;

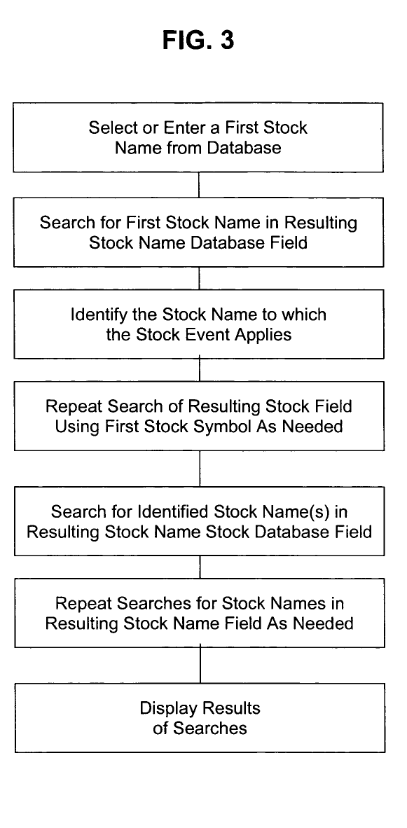

FIG. 4 is a flow chart of how the present invention may be used to determine stock basis for an estate; and

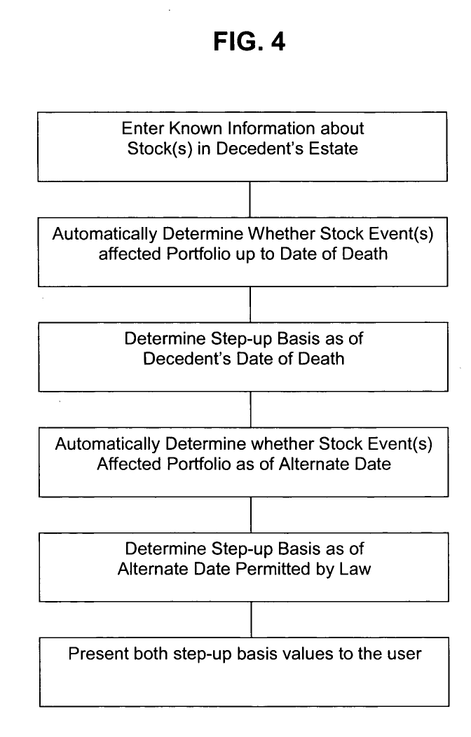

FIG. 5 is an illustration of a cost basis report of the present invention based on 2 transactions regarding AT&T stock

### DETAILED DESCRIPTION OF THE INVENTION

The present invention relates generally to a system and method for merging, comparing, and examining a user's stock transaction information with historical splits, spin-offs, mergers and other stock events in order to automatically determine present day cost basis of each stock. In addition, the present invention also may be used to determine other information about an investor's stock, including the identification and quantity of related stocks from spun-off companies that may be held by the investor as well as the appropriate cost basis associated with these additional stocks. Furthermore, the present invention also may be used to identify possible sources of where a stock currently held may have originated.

The present invention may have other beneficial uses as well. For instance, the present invention may be used in performing estate valuations, and also may be used to trace the impact of stock events on a stock certificate held by the investor. One of the principal advantages of the present invention is that these analyses may be performed automatically by accessing and applying a database and analysis program on a user's computer or through a communication network. This aspect of the invention greatly reduces the time needed to answer financial questions about an investor's stocks while also increasing the likelihood that the analysis will be performed accurately.

As mentioned above, one of the features of the present invention is that it involves creating and maintaining a database of stock event information. Some stock information is more readily available than others. For instance, historical stock price information is available from numerous web sites and other financial materials. Often, however, it can be difficult to find other stock event information that may impact the cost basis or amount of particular stocks held by the investor. For this reason, the present invention contemplates utilizing a database of stock event information which may be accessed as needed in order to answer different types of questions an investor may have about his or her portfolio or about a particular stock.

The stock event database is a collection of stock information that may be used to answer a variety of questions posed by an investor or by the investor's advisor. For instance, the stock event database may include records or entries for the following types of stock events:
1) X for Y splits, i.e., 2 for 1 split;
2) X for Y reverse splits;
3) Share dividends
4) Renaming of stock
5) Spin-offs
6) Additional spin-offs
7) Multiple, simultaneous spin-offs
8) Subsequent spin-off from a previous rename or spin-off
9) Mergers
10) Subsequent merger or rename of a previous rename or spin off
11) Acquisitions.

Skilled artisans would appreciate that other stock events likewise may be accounted for either on an ad hoc basis or systematically. For instance, the database used in the examples below would permit descriptive information about each stock event to be tailored or adjusted to take into account any unusual or particular circumstances, while numerical factors could be used to mathematically account for any type of stock event.

In order to track stock events, the database may include certain categories of information that may be useful for determining cost basis or answering other questions about a stock. For instance, in one embodiment of the invention the database may have the following categories of information:
1) the stock name and/or symbol and/or CUSIP identifier for which the stock event is applied;
2) the date when the stock first issued;
3) a description or characterization of the stock event;
4) the date of the stock event;
5) an affected or first stock share multiplier value;
6) an affected or first stock price divider value;
7) a resulting or second stock share multiplier value;
8) a resulting or second stock price multiplier value; and
9) a resulting or second stock name or symbol.

A more detailed discussion of what these categories are, and how they may be used, is provided below as well as in the illustrative examples that follow.

Preferably, the categories of information for a particular stock event are associated with each other in a manner that allows the categories to be selectively accessed and used for performing a requested analysis or for displaying results. In this manner, information in the database may be used to generate custom reports for different investors, for different stocks, for different analyses, or the like. Thus, it is preferred that the categories for stock events are organized similarly for all stock events in the database.

The size of the database of stock events can increase significantly as the total number of stocks included in it increases or as the time period covered by the database increases. Eventually, the total number of stock events may become so large that it is difficult to manage if not organized efficiently. Thus, it is preferred that event information pertaining to a particular stock is collected or stored in a consistent or uniform manner in the database, such as in an “event table”. This may allow the database to function more efficiently, and also may allow for more rapid confirmation that stock event information for any stock is correct and/or complete. Providing event tables also allows the database to be more easily expanded to include a longer time-frame.

Thus, an event table may comprise a database string of information representing general information about the stock and specific information regarding stock events related to it. While the format of an event table may vary depending upon how a database is structured, the following illustration of an event table for Cisco stock is one way an event table may be organized:

#NAME#, Cisco, 2/16/1990 (line feed)
#S#, CSCO (line feed)
Cisco, 2 for 1 split, 3/1/1991, 2, 2 (line feed)
Cisco, 2 for 1 split, 3/6/1992, 2, 2 (line feed)
Cisco, 2 for 1 split, 3/5/1993, 2, 2 (line feed)
Cisco, 2 for 1 split, 3/4/1994, 2, 2 (line feed)
Cisco, 2 for 1 split, 2/2/1996, 2, 2 (line feed)
Cisco, 3 for 2 split, 11/18/1997, 1.5, 1.5 (line feed)
Cisco, 3 for 2 split, 8/14/1998, 1.5, 1.5 (line feed)
Cisco, 2 for 1 split, 5/24/1999, 2, 2 (line feed)
Cisco, 2 for 1 split, 2/22/2000, 2, 2 (line feed)
#END#

In this illustrative example, the event table is formatted in a row and column format. In this example, the rows are delimited with line feeds, while columns are delimited by commas. The first row of the event table may comprise a header “#NAME#”, a stock name, and a start date. In addition, the final row of an event table may comprise a signal that the event table is concluded. As shown above, for instance, the final row may comprise the text “#END#”. After the header/name row and the symbol row, each subsequent row of an event table corresponds to a stock event. For example, the third row of the Cisco event table provided above represents a 2 for 1 stock split that occurred on Mar. 1, 1991.

In a preferred embodiment, each row of the event table may use either 5 or 8 fields (columns). For simple stock events like splits (which only effect one stock), only 5 fields are used. In more complex cases, like spin-off, mergers, renames, etc., however, 3 additional fields may be used to account for a second or resulting stock. Preferably, stock event information is included in the database in a consistent, uniform manner. More preferably, the organization of the database is such that it may be used for any kind of stock event. As will be appreciated by those skilled in the art, providing a database structure that covers all types of stock events provides a robust framework for performing the tasks described herein. There has been a long-felt need to achieve this structure, but until now it has not been done.

Thus, the comma delimited column and line feed delimited row string for Cisco provided above corresponds to the following stock events shown in Table 1:

TABLE 1
Stock Original Name: Cisco
Stock Start Date: Feb. 16, 1990
Stock Symbol: CSCO

| | | | Affected | Affected | Resulting | Resulting | |
|---|---|---|---|---|---|---|---|
| | | | or First | or First | or Second | or Second | Resulting |
| Stock name | | | Stock | Stock | Stock | Stock | or Second |
| Event | Event | Event | Share | Price | Share | Price | Stock |
| Applied to | Name | Date | Multiplier | Divider | Multiplier | Multiplier | Name |
| Cisco | 2 for 1 | Mar. 1, 1991 | 2 | 2 | | | |
| | Split | | | | | | |
| Cisco | 2 for 1 | Mar. 6, 1992 | 2 | 2 | | | |
| | Split | | | | | | |
| Cisco | 2 for 1 | Mar. 5,1993 | 2 | 2 | | | |
| | Split | | | | | | |
| Cisco | 2 for 1 | Mar. 4, 1994 | 2 | 2 | | | |
| | Split | | | | | | |
| Cisco | 2 for 1 | Feb. 2, 1996 | 2 | 2 | | | |
| | Split | | | | | | |
| Cisco | 3 for 2 | Nov. 18, 1997 | 1.5 | 1.5 | | | |
| | Split | | | | | | |
| Cisco | 3 for 2 | Aug. 14, 1998 | 1.5 | 1.5 | | | |
| | Split | | | | | | |
| Cisco | 2 for 1 | May 24, 1999 | 2 | 2 | | | |
| | Split | | | | | | |
| Cisco | 2 for 1 | Feb. 22, 2000 | 2 | 2 | | | |
| | Split | | | | | | |

As evidenced by Table 1, above, Cisco has not spun-off a company under a separate stock symbol. Consequently, categories for resulting or second share multiplier, resulting or second price multiplier, and resulting or second stock name are empty in the table above and are not found in the event table.

As illustrated in the event table for Cisco and Table 1 above, it is preferred that each row of an event table includes the stock name written identically as will be provided in the user interface and in reports, both of which are described in greater detail below. One benefit of using consistent terminology is that it simplifies the methods needed to search, maintain, or update the database. Using consistent terminology also may help facilitate the creation of drop down menus in the user interface that may be used to select a stock to analyze. In addition, it is believed that using consistent terminology reduces the likelihood that a user will mistake one stock for another. The use of consistent terminology also may be applied to the reports that are generated or displayed after using the database.

Alternatively, the database interface may be capable of receiving multiple names or identifiers for a given stock. For instance, a cross-reference table may be utilized to allow a user to enter a stock name in one of several accepted ways. The different ways that a user may enter a stock name may comprise any combination of the stock symbol, the full name of the company, commonly accepted abbreviated names of a company, and variations of spelling the company name.

The use of a cross-reference table with multiple identifiers for stocks could have at least two advantages. The first is that the user interface may be more able to receive data in a manner more consistent with particular preferences a user may have about how to identify a stock. Some users, for instance, may prefer to type the stock symbol for Cisco, while others may prefer the full company name or an abbreviated name. A cross-reference table also may include the ability to receive user-defined identifiers for any or all of the stocks in the database. In such cases where a cross-reference table is constructed so that it is capable of receiving user-defined identifiers, it is preferred that the user-defined term can be checked to make sure it is not the same as another identifier before it is accepted or entered. Where access to a database may be shared by many users, such as over a communication network, it is preferred that any user-defined terms for stocks reside at the location of the user rather than at the location of the database. Likewise, if multiple users are accessing the database from a single computer, different user-defined terms for stocks may be stored separately from the database. In other words, different user preferences may be utilized with the database on the same computer.

A second potential advantage of using a cross-reference table is that it may allow further customization of generated reports. For instance, reports generated from use of the database may use the same input initially provided by the user. Alternatively, the user may select to have reports generated using different terminology. For instance, an advisor may prefer to enter stock by the symbol, but generate reports for an investor or coworker using the company name or a different identifier for the stock. Further customization of reports using a cross-reference table may include providing two or more terms that identify a stock, such as by having the company name followed by the stock symbol in parentheses, or vice-versa.

As mentioned above, one embodiment of the present invention has a user interface having drop down menus. Initially, as illustrated in FIG. 6, a user may be presented with a choice of one or more functions that the database can perform. Preferably, one of the functions that a user may select comprises a determination of the cost basis of one or more blocks of stock related to a company.

For purposes of this disclosure, a “stock” may include any number of shares of stock, including fractional shares, a single share, or greater quantities of stock. In addition, “stock that may be related to a company” includes the purchase or sale of additional stock in the company, stock in other companies that may be acquired by the investor through stock events related to the company (such as from spin-offs of new companies or the like), and the purchase or sale of additional stock in said other companies.

As discussed above, different accounting methods can result in widely divergent cost bases depending on which stocks are selected or identified as sold. This is particularly the case when an investor makes multiple purchases of stock, or when an investor has multiple sales of stock over a period when one or more stock events have occurred. For this reason, it is preferable to specifically track and account for multiple purchases or acquisitions of stock. For example, an investor who purchases 10 shares of ABC stock for $10 per share, and then later purchases 10 more shares at $15 per share preferably would have two separate cost basis values.

As stock is sold, donated, or otherwise disposed from the investor's portfolio, it is possible to select or match the shares being removed from the portfolio depending on the accounting method used. To illustrate this point with the example above, if the investor who purchased 20 shares of ABC stock subsequently sells 10 shares for $20 a share before any stock event occurs, LIFO accounting would result in a gain of $5 a share and the investor holding 10 shares of ABC stock having a cost basis of $10 per share. In contrast, the same sale would result in a $10 per share gain if FIFO accounting is used, and the remaining 10 shares of ABC stock held by the investor would have a cost basis of $15 per share.

Since different accounting methods can affect the cost basis of the stocks held as well as the gains received, it is preferred that the user interface, the database, or some other component of the automated system is capable of receiving and accounting for multiple sales, donations, or other dispositions of stock. More preferably, the system is capable of utilizing different accounting methods to automatically identify and associate the appropriate shares in an investor's portfolio with the sale, donation, or other disposition of stock.

If a user indicates a desire to determine the cost basis of stock, the user may then be directed to enter information regarding stock transactions related to the stock that an investor may have undertaken. In general, four pieces of information per stock transaction are needed in order to determine cost basis of a block of stock: (1) the stock name; (2) the number of shares purchased or sold; (3) the date of the transaction; and (4) the total transaction amount. As mentioned above, different embodiments of the invention allow for a single stock name to be used to identify the stock or for multiple stock names to be used when the database, user interface, or other component is capable of recognizing or cross-referencing different terms associated with a stock.

Yet another reason for separately tracking and accounting for purchases, or acquisitions of stock as well as sales, donations, or other dispositions of stock is because the number of shares of stock sold, donated, or otherwise disposed of by an investor often does not correspond exactly to the number of shares received from a previous purchase or acquisition of stock. Separately accounting for changes to an investor's portfolio allows for the application of different accounting methods in a manner that can be illustrated to an advisor or an investor.

With regard to the step of providing the date of the transaction, one embodiment of the invention allows a user to either enter a transaction date or to select a date range in which the stock was purchased or sold. In this embodiment, the date ranges preferably are stock specific and define periods of time between stock events that affect cost basis calculations. For instance, the first day of each time period provided may correspond either to the first day of public trading of the stock or to a day that a cost basis affecting stock event took place. Likewise, the last day of a date range may generally correspond to either the last trading day or the calendar day before the next stock event took place.

One advantage of selecting these dates is that is helps ensure that basis affecting events, such as a stock split are properly included or excluded depending on the time the stock was purchased or acquired. For example, a user who only knows the approximate time when a stock was purchased or acquired may select a date range that covers this approximate time. Since the date range has no more than one stock event in it, there is a greater likelihood that all applicable stock events will be identified and that inapplicable stock events will be excluded. Preferably, a date range is selected such that if a stock event occurs within it, the date of the stock event is within 5 days of either the beginning or the end of the date range. More preferably, the date range is selected so that the stock event occurs on the first or last day of the date range,

If the date range between stock events is particularly long, however, a shorter time period may be utilized. For instance, in one embodiment, the date ranges associated with a stock may span periods of time that are about 10 years or less. In another embodiment, the date ranges are about 5 years or less, while in yet another embodiment the date ranges are about 3 years or less. In each of these embodiments, if the period of time between stock events is longer than the maximum date ranges, the period of time may be subdivided in any suitable manner. In one embodiment, the subdivided ranges are similar to each other in length. For example, a 20 year time period between stock events may be subdivided into 2, 3, 4, 5, 6, or 7 date ranges with each subdivided date range being approximately 10, 7, 5, 4, or 3 years. In general, it is believed that a long time period between stock events can be appropriately subdivided by dividing the range into from about 2 to about 7 time periods. It should be appreciated that subdividing date ranges in the manner explained above may be of particular use when the user requests to use an estimated total transaction amount based on historical data. Regardless of how a date range may be selected, it is preferred that each date range has at most one stock event, if any.

With regard to the total transaction amount, one embodiment of the invention allows a user to either enter a total transaction amount or to use historical price data to estimate what the total transaction amount might have been. While entering the actual total transaction amount provides the most accurate results, often a user may not have this information or may have lost or forgotten it. In these cases, it would be useful to provide the option to estimate the total transaction amount.

If an estimated date range has been provided for when the stocks were purchased or sold, the average price of the stock during the selected date range may be used in place of the actual transaction amount. The average stock price for the selected date range may correspond approximately to the average closing price of the stock during the time period, or may be selected in any other suitable manner. Other estimated values of a stock may also be used instead of the average closing price over the selected date range. For instance, the stock price may be estimated by selecting a mid-point value between the highest and lowest closing price of the stock during the date range. Thus, a stock that fluctuated between $20 a share and $30 a share during a date range may have an estimated cost of $25 a share. Any other suitable methods for estimating the share price or the total transaction amount also may be used.

When an actual transaction date has been provided, the estimated total transaction amount may be more precisely estimated than when only a date range is selected. For instance, the closing price of the stock on the transaction date may be used when estimating the total transaction amount. Alternatively, the opening share price, the average share price for the transaction date, or the approximate mid-point of the range in which the stock price fluctuated on the specified may be used instead of the closing price. Once again, any other suitable methods for estimating the share price or the total transaction amount also may be used.

Once sufficient information about the transaction has been provided, a user may then identify the transaction as either a purchase or a sale. Once a first transaction has been entered, it is preferred that the interface allows a user to selectively enter additional transactions or to generate a report regarding the entered information. Preferably, the entered transactions are displayed while the user decides whether to enter additional transactions or to request an analysis report.

Information regarding stock transactions may be entered manually or automatically. As mentioned above, one embodiment of the present invention uses drop-down menus that may be generated from the database itself. In one embodiment, the drop down menus allow a user to manually enter requested information in a manner that is consistent with the structure of the database. In this embodiment, the database may be parsed one or more times to generate the drop-down menus.

For example, the database may be parsed once to determine the stock names to include in a pull down menu so that the user can indicate to the database which stock is of particular interest. Once a stock is selected from the pull-down menu, the database may be parsed a second time determine the date ranges that may be provided. The database includes dates on which stock events occurred. These stock event dates may be used to establish initial date ranges, although as explained above one or more of these date ranges may be further subdivided if desired. Finally, the database may be parsed a third time along with the investor's transaction data to determine which stock events affect the output report.

Alternatively, transaction data regarding a stock need not be entered manually by the user. Instead, the database may be capable of automatically receiving stock transaction data from a user's or investor's electronic files or records. For instance, the present invention may be configured so that it is capable of receiving information from an investor's money management program, an electronic copy of portfolio information from an online broker, or the like. Because there are likely to be differences in how an investor, portfolio tracker, broker, financial website, or the like identifies stock transaction information, it may be beneficial to utilize a cross-reference table as previously described. More preferably, the user interface for the database will allow a user to confirm that the imported transaction information is correctly matched to the appropriate stock in the database. Once the transactions are confirmed, the database may be parsed to determine which stock events affect the output report.

Returning to the information that may be provided in a database string, the following provides a brief description of how fields may be parsed or used to determine, for instance, cost basis of stocks. As discussed previously, in a preferred embodiment of the invention, stock event information is collected and organized into event tables for each company in the database. More preferably, the event table lists the relevant stock events in chronological order. If every event table is organized in this manner, the steps involved in parsing the database in order to create drop-down menus may be further simplified. Additionally, providing a uniform order of each event table allows for easy identification of stock events that apply to the stock. This simplifies the routines or processes for identifying what stock events apply when generating the report.

When mergers, spin-offs, and re-names are involved, other names may follow the first name. If a cross-reference table is utilized, the listing of different names may be provided with one name designated for use when accessing the database. The use of the additional names will be discussed further in the context of spin-offs to illustrate, but not limit, how these names also may be used.

In some cases, the number of spin-offs and renames may become extensive. Due to the great number of spin-offs that may occur for some stocks, multiple name field lines may be used. Thus, a “#NAME CONTINUE#” field may be used in some cases to indicate that additional names are in the database.

A “stock start date” field may be used as a reference from as to the earliest date for which a transaction for the named stock can be entered. This applies to spin-off names, renames, and merger names, among others. This allows for multiple but related stocks to be followed and is beneficial when analyzing complex transactions.

A “stock name event applied to” field may be used to reference which stock the event applies to. If a stock spins-off a second stock and then the second stock splits, there must be some way to show that the split applies to the second stock and not the original stock. The “stock nave event applied to” field allows for multiple but related stocks to be followed and may be of particular value in complex transactions.

An “event name” field may be utilized in the database to provide a verbal description of the stock event. This text in this field may also be used in report pages. Due to the structure of the database in the illustrative embodiments described herein, the program does not need to know the type of stock event that took place in order to properly account for it. Providing this field in generated reports, however, may be beneficial in order for an advisor or investor to more readily understand how an automated analysis regarding cost basis was conducted. Thus, the information in this field may be copied without changes into a report table generated for a user or investor.

Alternatively, the information in an “event name” may comprise a symbol that represents or corresponds to a particular type of stock event. For instance, the symbol “21S” may represent “2 for 1 split”, “15RS” may represent a “1 for 5 reverse split”. Likewise, multiple symbols may be combined to establish the type of stock event. For instance, the symbol “32” may mean “3 for 2” and the symbol “S” may represent a split. Thus, when combined, a “32S” would represent a “3 for 2 split”. The order of the symbols may further aid in determining the type of event that it represents. For instance a two digit number preceding a letter symbol may represent the effect of a change in quantity of stock already held, while a two digit number following a letter symbol may represent how the quantity of stock is changing because of the generation of a spin-off stock.

If symbols are used, a separate look-up or cross-reference table may then be provided to convert the symbols into text for generating reports for a user or investor. Use of a look-up table or cross-reference table for descriptions of stock events may permit more rapid or more efficient revisions to what is provided in a generated report. Likewise, a look-up table or cross-reference table may be customized by different users according to their preferred text to describe a stock event. The features previously described for providing user-customized stock names may also apply in this context.

An “event date” field may be provided to identify the dates on which stock events occurred. As discussed above, these dates also may be used to create some or all of the date ranges for use in a drop down menu when transaction information about a stock is being entered manually as well as to generate reports requested by the user. Preferably all of the stock event dates in the event table are used to generate date ranges, where the first day of the date ranges corresponds to the event dates. In one embodiment the last day of each date range corresponds to the day before a stock event so that the entirety of the time period covered by the database for a particular stock is divided only by stock event dates. As described above, however, another embodiment of the invention contemplates further subdividing date ranges if, for example, the period of time between stock events is long.

The event date field also may be used to identify what stock events apply to the user's portfolio by comparing the investor's data regarding purchases and sales of the stock with the event dates in the event tables.

As will be illustrated below, it is believed that all stock events may be described numerically with 4 or fewer mathematical values that can be used to adjust or establish the quantity and value of stocks held by an investor. Two values are directed to adjust share amounts, and two are directed to adjust share prices or cost per share basis. The following embodiment identifies these values as “stock share multiplier”, “stock price divider”, “spin-off share multiplier”, and “spin-off price multiplier”.

An “affected or first stock share multiplier” is used to adjust the number of shares of stock when a stock event takes place. The value is multiplied with the number of shares of stock prior to the stock event in order to arrive at the number of shares of stock after the stock event. For instance, the affected or first stock share multiplier for a stock that undergoes a 2 for 1 split is 2, thereby doubling the number of shares outstanding for that stock. For a 3 for 2 split, the affected or first stock share multiplier will be 1.5, and it would be 1.2 for a 5 for 4 split. If a stock is renamed, the affected or first stock share multiplier is 0 so that the number of the old stock is zero. The same value may be used if a company ceases to exist for any other reason, such as bankruptcy, takeovers, or when the company merges into another company. When the company spins-off a portion of its business as a separate entity, the affected or first stock share multiplier may be 1 or less, depending on how the spin-off is structured. For instance, if a spin-off does not affect the original company's stock, the affected or first stock share multiplier is 1. Preferably, a stock share multiplier or similar mathematical value described below is provided in every instance where there is a stock event in the database, even if the number of shares remains unchanged.

While the features of an affected of first stock share multiplier have been described above in a manner where a single numerical value is multiplied with the number of shares of an investor's stock in order to arrive at the new number of shares held by the investor after the stock event, skilled artisans would appreciate that several variations of this may be utilized without departing from the spirit and scope of the invention.

For instance, an affected or first stock share divider may similarly be used by inverting the ratio of the post-event number of stock to pre-stock event number of stock described above. Thus, a 2 for 1 stock split may be expressed as an affected or first stock share divider of 0.5, which can be divided into the number of shares of stock held by an investor before the stock event in order to arrive at the new number of shares after the stock event. Using a divider instead of a multiplier to adjust the number of shares of a stock, however, may require using repeating fractional numbers that may be difficult to account for stock events as accurately as using a multiplier. For instance a 3 for 2 stock split expressed as a stock share divider instead of a multiplier would be 0.6666. While using a stock share multiplier for a reverse stock split may also result in repeating fractions (e.g., a 2 for 3 reverse stock split would have a stock share multiplier of 0.6666 ), it is believed that using a multiplier instead of a divider will reduce the likelihood of a repeating fraction because stock splits are more common than reverse stock splits.

Another variation of how the number of shares of stock may be adjusted is by separately multiplying the number of shares of stock held before the stock event by the numerator of the ratio of post-stock event shares to pre-stock event shares and dividing result by the denominator of the ratio. For example, a 3 for 2 stock split of 100 shares of stock could be adjusted by multiplying 100 by 3 and dividing the result by 2 to arrive at 150 shares after the stock event. Likewise, a reverse stock split of 2 for 3 of 150 shares of stock may be adjusted by multiplying by 2 and dividing the result by 3 to arrive at 100 shares after the stock event. Thus, one variation of the invention may involve applying numerator and denominator values of the ratio described above in two steps. The order in which these values are applied to arrive at the post-stock event number of shares is not critical, and therefore may be reversed.

These and other variations that may be contemplated by skilled artisans could be used in place of the illustrative examples for any of the mathematical values described herein.

An “affected or first stock price divider” may be used to adjust the amount of money or basis allocated to shares of stock by dividing the value into the basis of the stock before the stock event in order to arrive at the basis of the stock after the stock event. For instance, for a 3 for 1 split of a stock having a basis of $30 per share, a stock price divider of 3 will be used to adjust the basis to $10 per share. Likewise, a 2 for 1 split will have a stock price divider of 2, a 3 for 2 stock split will have a stock price divider of 1.5, and a 5 for 4 stock split will be 1.2. Since stock splits resulting in a greater number of outstanding shares are more common than reverse stock splits that decrease the number of outstanding shares, using a divider instead of a multiplier helps reduce the occurrence of repeating fractions. For instance, accounting for a 3 for 2 stock split results in an affected or first stock price divider of 1.5, whereas using a multiplier would result in a value of 0.6666. In addition, making this value a divider will cause the affected or first stock share multiplier and the affected or first stock price divider to be the same for stock splits, which are believed to be the most common of stock events.

When a stock event only affects the first or original stock held, the information discussed above is sufficient to describe and account for virtually and scenario. Thus, stock events of this nature can be described with these five fields of information: (1) the stock name; (2) the stock event name; (3) the stock event date; (4) the affected or first stock share multiplier; and (5) the affected or first stock price divider.

For stock events resulting in or affecting a second stock, additional information about the second stock may be provided in additional fields. In particular, the additional information could comprise 3 additional fields of information: (6) the resulting or second stock share multiplier; (7) the resulting or second stock price multiplier; and (8) the resulting or second stock name.

Thus, stock events affecting only one stock may be described in an event table with 5 fields of information, while stock events affecting an additional, second stock may be described with eight fields of information.

For stock split events, the affected or first stock price divider is the same as the affected or first stock share multiplier, however, these two values may be different for other types of stock events. Since stock split events are the most common events, it is preferred that the event table is structured to make this case the simplest in the database. For example a spin-off often will have an affected or first stock share multiplier of 1, whereas the affected or first stock price divider often will be greater than 1 since some of the value of the “applied to” stock will be assigned to the spin-off stock. Typically, companies will declare or assign the value for spin offs. Thus, a stock spin-off may affect the cost basis of the original stock. For example, if 85% of value is assigned to the original stock and 15% is assigned to the spun-off stock, then the affected or first stock price divider would be 1.17647, which is 1/0.85. This example assumes a change in basis of the original stock occurred without changing the number of outstanding shares of the original stock. If the number of shares of the original stock also changes, then the affected or first stock price divider would be the percentage of new shares divided by the percentage of value assigned.

When a stock is renamed, the price of the old stock should be zero or so close to zero that for accounting purposes the difference is inconsequential. For instance, when using an affected or first stock price divider the value used may be 9,999,999 or greater, thereby driving the price per share of the old stock to negligible levels for nearly any amount of shares held by most investors.

As mentioned above, other approaches may be used to adjust stock price for a stock event. In some instances a multiplier may be used, which may be of particular use when a stock is renamed or in other circumstances when the price should be adjusted to zero. Likewise, separately applying a ratio of post-stock event price to pre-stock event price also may be used.

A “resulting or second stock share multiplier” may be used for stock events such as a rename, spin-off, or merger where new stock that is different from the original stock results from the stock event. The value is multiplied by the number of shares of the first, original stock held by the investor to arrive at the number of shares of the second, new stock. Thus, for a simple rename where the number of shares does not change as a result of the name change, the resulting or second stock share multiplier is 1. This indicates that for every one share of the original stock held by the investor will result in one share of the new stock. If, however, one new rename share is issued for every 5 shares of the previous name stock, the resulting or second stock share multiplier would be 0.2.

The resulting or second stock share multiplier may be applied in the same manner for spin-offs and mergers. For example, the resulting or second stock share multiplier would be 0.3 for a spin-off of 3 shares of new stock for every 10 shares of the original stock. For a merger where 2.37 shares of new stock will be exchanged in place of every 1 share of original stock, the resulting or second stock share multiplier would be 2.37.

Preferably the database is capable of recognizing that a non-zero number entered for this value indicates that a new stock is being added to the investor's holdings. When generating or displaying reports for the user or investor, the new stock resulting from a stock event can be displayed as a separate column. Since many stock events do not result in the investor having additional stock under a different name, the mathematical values for handling these types of transactions are not always needed in order to analyze an investor's holdings. Since they are not always needed, it is preferred that the database does not require a value to be provided for them for every stock event. Thus, it is preferred that if the field in the database for resulting or second stock share multiplier is blank or zero, a new stock and stock column in the output report will not be generated or displayed.

A “resulting or second stock price multiplier” is used to assign a value to the new stock based on the carry forward basis of the previous stock. Thus, for a simple rename where the number of shares does not change as a result of the name change, the resulting or second stock price multiplier is 1. When new stock is spun-off from a first company, a portion of the cost basis of the original stock is applied to the new stock. For example, if 1 new share of stock is issued for every 4 old shares, with the value assignment of 80% staying with original stock, and 20% going to new stock, the entry in the event table for this stock event would be as follows:
old, spin off, data, 1, 1.25, 0.25, 0.8, new stock

In this example, the affected or first stock price divider is arrived at by dividing the percentage of shares by the percentage of value, which in this case is 1/0.8, or 1.25. Moreover the second or resulting stock price multiplier is arrived at by dividing the percentage value of the resulting or second stock by the second stock share multiplier, 0.2/0.25, or 0.8.

For stock events where resulting or second stock multipliers are used, a “resulting or second stock stock name” may be used to identify the stock. The resulting or second stock stock name may be used to further track and account for purchases, sales, or other stock events related to the new stock. In one embodiment, the resulting or second stock name is used to identify the stock in reports generated or displayed.

Output Reports

Once a user has entered the stock transactions, a report may be compiled by merging the transaction information with the associated stock event information in the database. The output report may be displayed to a user or investor, may be saved as an electronic file, may be downloaded or otherwise transferred for use by another program (such as a spreadsheet, accounting software, tax preparation software, or the like), or may be printed.

The complexity of the output report may depend upon several factors, such as the number of transactions, the length of time that the investor has been held the stock, and the number and complexity of stock events. Thus, the size of the output reports may vary greatly. Because of this, the format of the report may be varied in order to clearly present the results of the analysis. For instance, the results of a cost basis evaluation may be presented a transaction or stock event shown in each row and different blocks of stock shown in each column. In the illustrative embodiment discussed below, the report is formatted in landscape with variable size font.

Each transaction entered by the user will cause a new row to be generated in the output report. Likewise, every purchase of additional stock will also cause a new column to be generated in the output report. Every stock event from the database that occurs after the first purchase will generate a new row in the output report. If this stock event has a non-zero value for the “spin-off stock multiplier”, a new column will also be generated in the output report corresponding to the new stock name.

The following example further illustrates how an output report may be generated. First, a user enters the following transactions for purchases and sales of Cisco stock:

| | | | |
|---|---|---|---|
| Purchase on | May 7, 1990 | 100 Cisco | for $2,500 |
| Purchase on | Dec. 7, 1992 | 200 Cisco | for $15,000 |
| Purchase on | May 27, 1993 | 400 Cisco | for $22,000 |
| Sold on | Sep. 21, 1993 | 200 Cisco | for $9,000 |
| Purchase on | Jun. 12, 1994 | 200 Cisco | for $4,700 |
| Sold on | Jul. 13, 1995 | 500 Cisco | for $28,500 |
| Sold on | Aug. 28, 1997 | 1600 Cisco | for $120,000 |

The user may then be offered to select what accounting method to apply in order to calculate cost basis for the blocks of stock held by the investor. In this example, a FIFO method is used. As mentioned above, however, a user preferably is able to select from a variety of accounting methods. It is preferred that all of the options provided to a user are allowable by the IRS. Once the user has selected the FIFO accounting method, the transactions are then compared to stock events provided in the database in an event table for Cisco. This comparison and application of FIFO accounting rules results in the following output report:

| | | Total | Numb. | Numb. | Numb. | Numb. | Capt. |
|---|---|---|---|---|---|---|---|
| | | shares | shares | shares | shares | Shares | Gain |
| | | averg. | @ cost/ | @ cost/ | @ cost/ | @ cost/ | Or |
| Stock Event | Date | cost | share | share | share | share | (Loss) |
| Buy 100 for | May 7, 1990 | 100 @ | 100 @ | | | | |
| $2,500 | | $25.00 | $25.00 | | | | |
| 2 for 1 | Mar. 15, 1991 | 200 @ | 200 @ | | | | |
| Split | | $12.50 | $12.50 | | | | |
| 2 for 1 | Mar. 20, 1992 | 400 @ | 400 @ | | | | |
| Split | | 6.25 | $6.25 | | | | |
| Buy 200 for | Dec. 7, 1992 | 600 @ | 400 @ | 200 @ | | | |
| $15,000 | | $29.1667 | $6.25 | $75.00 | | | |
| 2 for 1 | Mar. 19, 1993 | 1,200 @ | 800 @ | 400 @ | | | |
| Split | | $14.5833 | $3.125 | $37.50 | | | |
| Buy 400 for | May 27, 1993 | 1,600 @ | 800 @ | 400 @ | 400 @ | | |
| $22,000 | | $24.6875 | $3.125 | $37.50 | $55.00 | | |
| Sell 200 for | Sep. 21, 1993 | 1,400 @ | 600 @ | 400 @ | 400 @ | | $8,375 |
| $9,000 | | $27.7679 | $3.125 | $37.50 | $55.00 | | |
| 2 for 1 | Mar. 15, 1994 | 2,800 @ | 1200 @ | 800 @ | 800 @ | | |
| Split | | $13.8839 | $1.5625 | $18.75 | $27.50 | | |
| Buy 200 for | Jun. 12, 1994 | 3,000 @ | 1200 @ | 800 @ | 800 @ | 200 @ | |
| $4,700 | | $14.525 | $1.5625 | $18.75 | $27.50 | $23.50 | |
| Sell 500 for | Jul. 13, 1995 | 2,500 @ | 700 @ | 800 @ | 800 @ | 200 @ | $27,719 |
| $28,500 | | $17.1175 | $1.5625 | $18.75 | $27.50 | $23.50 | |
| 2 for 1 | Feb. 16, 1996 | 5,000 @ | 1400 @ | 1600 @ | 1600 @ | 400 @ | |
| Split | | $8.5587 | 0.7813 | $9.3750 | $13.75 | $11.75 | |
| Sell 1600 | Aug. 28, 1997 | 3400 @ | | 1400 @ | 1600 @ | 400 @ | $117,031 |
| for $120,000 | | 11.7132 | | $9.3750 | $13.75 | $11.75 | |
| 3 for 2 | Dec. 16, 1997 | 5,100 @ | | 2100 @ | 2400 @ | 600 @ | |
| Split | | $7.8088 | | $6.25 | $9.1667 | $7.8333 | |
| 3 for 2 | Sep. 15, 1998 | 7,650 @ | | 3150 @ | 3600 @ | 900 @ | |
| Split | | $5.2059 | | 4.1667 | $6.1111 | $5.2222 | |
| 2 for 1 | Jun. 21, 1999 | 15,300 @ | | 6300 @ | 7200 @ | 1800 @ | |
| Split | | $2.6029 | | 2.0833 | $3.0556 | $2.6111 | |
| 2 for 1 | Mar. 22, 2000 | 30,600 @ | | 12600 @ | 14400@ | 3600 @ | |
| Split | | $1,3015 | | 1.0417 | 1.5278 | $1.3056 | |

As can be seen in the output report, each transaction and stock event results in the generation of a row in the output report. A new column is generated for each purchase of Cisco stock. Splits, however, do not result in the generation of a new column, but instead change the number and basis of the stock in the existing columns.

Preferably, the report allows a user or investor to apply hypothetical scenarios to see the consequences of different financial strategies being considered. For instance, the report allows a user or investor to automatically calculate what gains may result from the sale of additional stock. In one embodiment, the database and/or report is capable of automatically obtaining the current price at which the stock is being traded, such as by accessing the information over a communication network.

Another hypothetical scenario the report may allow a user or investor to examine is what the tax consequences may have been for past or future transactions if a different accounting method were used. By presenting the effect of different accounting methods in this manner, an investor may better understand how different accounting methods may impact their financial strategy.

For example, using the same transactions for the purchase and sale of Cisco stock provided above, a LIFO accounting method results in the following:

| | | Total | Numb. | Numb. | Numb. | Numb. | Capt. |
|---|---|---|---|---|---|---|---|
| | | shares | shares | shares | shares | Shares | Gain |
| | | averg. | @ cost/ | @ cost/ | @ cost/ | @ cost/ | Or |
| Stock Event | Date | cost | share | share | share | share | (Loss) |
| Buy 100 for | May 7, 1990 | 100 @ | 100 @ | | | | |
| $2,500 | | $25.00 | $25.00 | | | | |
| 2 for 1 | Mar. 15, 1991 | 200 @ | 200 @ | | | | |
| Split | | $12.50 | $12.50 | | | | |
| 2 for 1 | Mar. 20, 1992 | 400 @ | 400 @ | | | | |
| Split | | 6.25 | $6.25 | | | | |
| Buy 200 for | Dec. 7, 1992 | 600 @ | 400 @ | 200 @ | | | |
| $15,000 | | $29.1667 | $6.25 | $75.00 | | | |
| 2 for 1 | Mar. 19, 1993 | 1,200 @ | 800 @ | 400 @ | | | |
| Split | | $14.5833 | $3.125 | $37.50 | | | |
| Buy 400 for | May 27, 1993 | 1,600 @ | 800 @ | 400 @ | 400 @ | | |
| $22,000 | | $24.6875 | $3.125 | $37.50 | $55.00 | | |
| Sell 200 for | Sep. 21, 1993 | 1,400 @ | 800 @ | 400 @ | 200 @ | | ($2,000) |
| $9,000 | | $20.3571 | $3.125 | $37.50 | $55.00 | | |
| 2 for 1 | Mar. 15, 1994 | 2,800 @ | 1600 @ | 800 @ | 400 @ | | |
| Split | | $10.1786 | $1.5625 | $18.75 | $27.50 | | |
| Buy 200 for | Jun. 12, 1994 | 3,000 @ | 1600 @ | 800 @ | 400 @ | 200 @ | |
| $4,700 | | $11.0667 | $1.5625 | $18.75 | $27.50 | $23.50 | |
| Sell 500 for | Jul. 13, 1995 | 2,500 @ | 1600 @ | 800 @ | 100 @ | | $15,550 |
| $28,500 | | $8.1000 | $1.5625 | $18.75 | $27.50 | | |
| 2 for 1 | Feb. 16, 1996 | 5,000 @ | 3200 @ | 1600 @ | 200 @ | | |
| Split | | $4.0500 | 0.7813 | $9.3750 | $13.75 | | |
| Sell 1600 for | Aug. 28, 1997 | 3400 @ | 3200 @ | 200 @ | | | $104,125 |
| $120,000 | | 1.2868 | 0.7813 | $9.3750 | | | |
| 3 for 2 | Dec. 16, 1997 | 5,100 @ | 4800 @ | 300 @ | | | |
| Split | | $0.8578 | 0.5208 | $6.25 | | | |
| 3 for 2 | Sep. 15, 1998 | 7,650 @ | 7200 @ | 450 @ | | | |
| Split | | $0.5719 | 0.3472 | 4.1667 | | | |
| 2 for 1 | Jun. 21, 1999 | 15,300 @ | 14400 @ | 900 @ | | | |
| Split | | $0.2859 | 0.1736 | 2.0833 | | | |
| 2 for 1 | Mar. 22, 2000 | 30,600 @ | 28800 @ | 1800 @ | | | |
| Split | | $0.1430 | 0.0868 | 1.0417 | | | |

Spin-Offs

Using the stock event data described above, the present invention allows easy, automatic analysis of spin-offs. A spin-off is similar to a split in that the cost per share basis of the original share will change. Unlike a split, however, the share amount of the original shares may not always change.

The following example illustrates how the present invention may automatically handle these types of stock events. An investor purchases 100 shares of XYZ stock at $100 per share for a total price of $10,000. Subsequently, XYZ spins-off a portion of its business as ABC company at 1 share of ABC for every 2 shares of XYZ. This stock event would leave the investor with the same 100 shares of XYZ stock plus 50 shares of ABC stock. In this example, 80% of the value of XYZ remains with XYZ and the remaining 20% of the value of XYZ is assigned to ABC. Assuming this spin-off occurred on Sep. 9, 1999, the database string describing this stock event would be as follows:
XYZ, Spin-off I ABC for every 2 XYZ, Sep. 9, 1999, 1, 1.25, 0.5, 0.4, ABC

Thus, the affected or first stock share multiplier in this example is 1, the affected or first stock price divider is 1.25 (1 divided by 0.8=1.25), the resulting or second share multiplier is 0.5, and the resulting or second price multiplier is 0.4 (0.2/0.5=0.4, which is the allocation percentage of value for the second or resulting stock divided by the number of shares percentage for the second or resulting stock). When these values are applied to the investor's holdings of 100 shares, the result of the stock event is as follows:
New Number of Shares in XYZ=100×1=100 shares
Price per share basis for XYZ=$100 ) 1.25=$80 per share
New Number of shares in ABC=100×0.5=50 shares
New price per share basis for ABC=$100×0.4=$40 per share

Total Cost Basis Assignment Value
100 shares XYZ*$80=8,000 (80%)
50 shares of ABC*$40=2,000 (20%)

Another, more complex example can be provided based on the same purchase 100 shares of XYZ stock at the price of 100 per share, but having a different spin-off event. In particular, the terms of the spin off in this example would be that an investor holding 10 shares of XYZ stock before the spin off would have 8 shares of XYZ after the spin off and 5 shares ABC. In addition, the allocation of the basis would be 70% for XYZ and 30% for ABC. Using this spin-off information, the database string for this stock event would be as follows:
XYZ, Spin-off 5 ABC and 8 XYX for every 10 XYZ, Sep. 9, 1999, 0.8, (number of shares/percentage allocation)=0.8/0.7=1.1428, 0.5, 0.6, ABC

Thus, the affected or first stock multiplier is 0.8, the affected or first stock price divider is 1,1428 (0.8/0.7=1.1428), the resulting or second share multiplier is 0.5, and the resulting or second share price multiplier is multiplier is 0.6 (0.3/0.5=0.6, which is allocation percentage of value for the second or resulting stock divided by the number of shares percentage for the second or resulting stock). When these values are applied to the investor's holdings of 100 shares, the result of the stock event is as follows:
New Number of Shares in XYZ=100×0.8=80 shares
Price per share basis for XYZ=$100 ) 1.1428=$87.50 per share
New Number of shares in ABC=100×0.5=50 shares
New price per share basis for ABC=$100×0.6=$60 per share

Total Cost Basis Assignment Value
80 shares XYZ*$87.50=7,000 (70%)
50 shares of ABC*$60=3,000 (30%)

This more complex example illustrates the advantage of having an affected or first stock share multiplier and an affected or second stock price divider. For a simple 2 for 1 split, both values for the multiplier and divider would be 2. Thus, for simple stock splits a single value may be used to adjust both the number of shares and the share price. Using a single value, however, does not permit accounting for more complex stock events that can change the stock price and amount of stock differently.

For instance, for spin-off stock events the affected or first stock share multiplier often is 1 or a fraction less than 1, while the affected or first stock price divider is greater than 1. In the second example above, for instance, the affected or first stock multiplier would be 0.8 and the affected or first stock price divider is 1.25. When the multiplier and divider values are applied to the investor's holdings of 100 shares, the result of the stock event is as follows:
New Number of Shares in XYZ=100×0.8=80 shares
New Cost Basis for XYZ=$100 ) 1.25=$80
New Number of shares in ABC=100×0.5=50 shares
New Cost Basis for ABC=$100×0.2=$20

In both examples provided above, an output report would show the spin-off stock in a new column of the report just like a different purchases would be shown in a separate columns. Additionally, an event table for XYZ stock would have include the stock event database string in the manner described above. Because non-zero numerical values are provided for spin-off multipliers, the system automatically recognizes that the stock event involves the investor getting new stock.

The system may be further designed to allow for more than one stock event to occur on the same day, such as when a company has multiple spin-offs on the same day. For instance, if drop down menus for the user interface uses stock event dates to create date ranges, the system preferably is able to recognize these coincident dates so that only one date range is provided instead of several beginning on the same day. In one embodiment, the present invention is able to allow for at least 5 stock events in a single day, while in another embodiment the system can allow for at least 7 stock events in a single day. More preferably, the system is capable of recognizing and properly handling any number or stock events that may occur on the same day.

This will allow for scenarios such as the divestiture by AT&T of 7 regional bell operating companies on the same day. It is preferred, however, that stock events occurring on the same day are nevertheless treated separately when reported to a user or investor. Thus, multiple stock events will be included on separate event lines in the database with the multiple events having the same event date. This structure of handling different stock events individually even if they occurred at the same time allows the database architecture to remain uniform.

Stock Rename

In essence, the renaming of stock is one variation of a stock spin-off where the original stock amount and price is zero after the stock event. Thus, the stock report will shown none of the original shares remaining. When the only change taking place is in the name of the stock, the resulting or second stock multiplier and resulting or second cost multiplier will both be 1 so that the renamed stock will have the same number of shares and cost basis as the original stock. Thus, the same software engine that is used to analyze spin-offs can be used to analyze renamed stock. In order to better illustrate the stock event, it is preferred that a renamed stock is shown in an output report in a different column than the original stock. Thus, if one share of XYZ stock is renamed as one share of ABC stock, the database string for this stock event would be as follows:
XYZ, XYZ renamed to ABC, Sep. 9, 1999, 0, 9999999, 1, 1, ABC

Stock Merges Into Another Stock

If an investor's stock merges into another stock, the stock event can also be treated in the same manner as a spin-off or renaming of the stock. In this case, the affected or first stock share multiplier will be 0. Thus, the output report will show none of the original shares remaining after the stock event. The resulting or second stock multiplier will represent the number of shares of the new merged stock that the original stock will turn into. The resulting or second price multiplier will be used to adjust to new merged cost basis. For a simple case where 1 share of XYZ merges into 1 share of ABC, the database string would be as follows:
XYZ, XYZ merged into ABC 1 for 1, Sep. 9, 1999, 0, 9999999, 1, 1, ABC

For a case where 1 share of XYZ merges into 1.5 shares of ABC, the database string would look like:
XYZ, XYZ merged into 1.5 shares of ABC, Sep. 9, 1999, 0, 9999999, 1.5, 0.66666, ABC

It is notable in this example where a stock merges into another stock, the price allocation for the resulting or second stock is simply the inverse of the resulting or second stock share multiplier. The allocation percentages used above in the examples of spun-off stock are not used.

If organized properly, such as by using the format provided in many of the examples provided herein and by including a “event applied to” field that identifies to which stock the event applies, the database and parsing program can easily account for subsequent stock events. As the database is parsed, the system determines which column of stock information in the report for which the split, spin-off, or merger will be applied.

The following event table for AT&T illustrates one embodiment of the invention that is capable of handling one of the most complex stock scenarios in history.

[Insert AT&T Event Table]

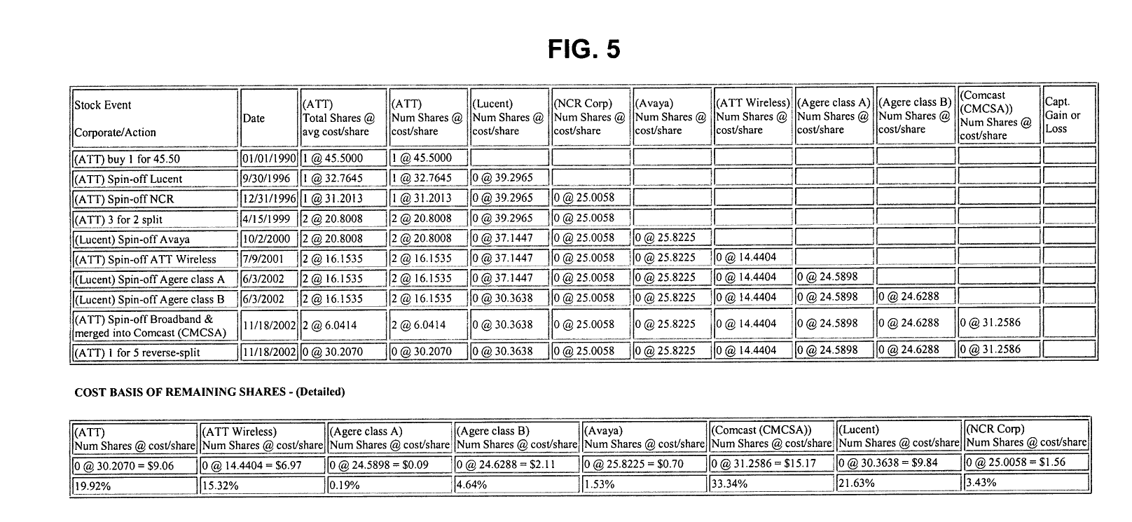

Using this event table, it is possible to automatically determine the current cost basis and shares held by an investor who purchased 1 share of AT&T stock on Jan. 1, 1990 for $45.50. An illustration of the automated results that may be generated as a result of the present invention is illustrated in FIG. 5.

Thus, the architecture of the database allows for accurate and automatic calculation of cost basis for even one of the most complex stocks.

The time period covered by the database should be sufficiently long so that most investors' transactions can be properly accounted for using any of the accounting options available to the user. In one embodiment, the time period covered by the database is at least about 10 years. In another embodiment, the time period covered by the database is at least about 30 years. In yet another embodiment, the time period covered by the database is at least about 50 years. Preferably, the database covers all stock events for each stock in the database.

The number of stocks covered by the database also should be sufficiently large so that it can be used by many investors. In one embodiment, the database comprises stock event information for at least 100 publicly traded stocks. In another embodiment, the database comprises stock event information for at least about 200 stocks. In yet another embodiment, the database comprises stock event information for at least about 500 stocks, and more preferably comprised stock event information for at least about 1000 stocks. Preferably, the stocks in the database are those that are widely held or actively traded. For instance, in one embodiment of the invention the database has all of the stocks on the S&P 500, while in another it has all stocks in the Russell 2000. In yet another embodiment, the database comprises stock event information for about 75 percent or more of the publicly traded stocks in the United States, and more preferably comprises stock event information for about 90 percent or more of the publicly traded stocks in the United States.

Detecting Possible Origins of a Stock

The present invention may also be used to perform other types of analysis in addition to determining cost basis of an investor's stocks. In one embodiment, for example, the system is capable of identifying where a stock held by an investor may have come from when the investor did not purchase the stock and does not recall from where it came.

If this feature is offered as an option in an initial screen or display of the user interface, selection of this option by the user may direct the user to a second display or screen where information regarding the stock is requested. The only information needed in order to identify where a stock may have originated is that the user identifies the stock in question. In one embodiment a drop-down menu may be provided listing the stocks in the database. To identify a stock, the user simply selects the name out of the drop-down list that corresponds to the stock. Alternatively, and as mentioned above, the system may be capable of receiving multiple names for the stock.

Once the stock has been identified by the user, the database may be parsed or analyzed for stock events that would result in the creation or addition of the identified stock in an investor's portfolio. In the examples provided herein, the resulting or second stock name in a datastring corresponds to the name of stock that results from a stock event such as a spin-off, merger, renaming, or the like. Skilled artisans would appreciate, however, that the fields of the database may be structured or organized differently without departing from the spirit and scope of the invention.

If parsing the database results in one or more matches of the stock name in the second resulting stock datastring, then the field of the datastring corresponding to the “stock name event applied to” for each matched stock event may examined in a similar fashion to identify possible additional stocks from which the stock in question may have originated. In the examples provided herein, the 1^{st} field of a datastring for a stock event comprises the “stock name event applied to” information. The names in these fields may be searched in order to trace the origin of the stock in question.

Thus, in one embodiment the analysis performed may find the stocks having stock events that directly led to the creation of the stock in question. Once identified, the investor or user may then determine whether these stocks are or were in the investor's portfolio during the relevant time period when the stock event occurred.

More preferably, however, the analysis initially performed to find stock events resulting in the stock of interest is repeated for each possible originating stock until the entire tree or family of stock events that might indirectly have resulted in the stock in question are identified.

The following example further illustrates this embodiment of the invention. In this example, a user identifies Avaya as a stock in an investor's portfolio for which the origin of the stock is unknown. Once Avaya is identified, the database may be parsed and analyzed for any match for this stock name in the field for the resulting or second stock name. As explained above, a match in this field or column indicates that a stock event has occurred which resulted in Avaya stock. Assuming that in this example the relevant stocks are included in the database, parsing or searching the database in this manner would result in the following database string:
Lucent, Spin-off Avaya, Oct. 2, 2000, 1, 1.0573, 0.08333333, 0.65712, Avaya

This result could be reported to the user by creating a report such as:
(8^{th} field) came from (1^{st} field)((2^{nd} field) on (3^{rd} field))

Using the database structure provided above, the generated report would provide the following information:
(resulting or second stock name) came from (stock name event applied to) ((event name) on (event date)
which would yield:
Avaya came from Lucent (Lucent Spin-off Avaya on Oct. 2, 2000)

No other matches for Avaya would result by searching the resulting or second stock name. Parsing or searching the database again for Lucent, however, would yield the following:
ATT, Spin-off Lucent, Sep. 30, 1996, 1, 1.3887, 0.324084, 0.86366, Lucent

Applying the report string above to these results would yield:
Lucent came from ATT (ATT Spin-off Lucent on Sep. 30, 1996)

The database may then be parsed or searched once again for AT&T in order to identify the entire tree or family of stocks that may have resulted in Avaya stock either directly or indirectly. This search for AT&T would have resulted in no datastring being found, thereby indicating only two possible sources of Avaya stock.

A more complex example of this feature of invention is SBC stock. After a user selects SBC stock, the database may be parsed in the same manner described above for Avaya. This would result in four datastring matches as follows:
Southwestern Bell, name change to SBC, Apr. 28, 1995, 0, 99999, 1, 1, SBC
Pacific Telesis, merged into SBC, Apr. 1, 1997, 0, 99999, 0.73145, 1.36715, SBC
Southern New England Tel, merged into SBC, Oct. 26, 1998, 0, 99999, 1.7568, 0.5692, SBC
Ameritech, merged into SBC, Oct. 8, 1999, 0, 99999, 1.316, 0.75988, SBC

When multiple matches are found, the format of the result may be as follows:
SBC came from Southwestern Bell (Southwestern Bell name change to SBC on Apr. 28, 1995) OR
SBC came from Pacific Telesis (Pacific Telesis merged into SBC on Apr. 1, 1997) OR
SBC came from Southern New England Tel (Southern New England Tel merged into SBC on Oct. 26, 1998) OR
SBC came from Ameritech (Ameritech merged into SBC on Oct. 8, 1999)

As above, the database may be parsed or searched again using the stocks found from the first parsing of the database, which in this case were Southwestern Bell, Pacific Telesis, Southern New England Tel, and Ameritech. Preferably, this process may be repeated until all possible origins of the stock in the database have been identified. Once the search is completed, the report may appear as follows:
SBC came from Southwestern Bell (name change to SBC on Apr. 28, 1995)
Southwestern Bell came from ATT (Divestiture—Southwestern Bell on Jan. 1, 1984) OR
SBC came from Pacific Telesis (merged into SBC on Apr. 1, 1997)
Pacific Telesis came from ATT (Divestiture - Pacific Telesis on Jan. 1, 1984) OR
SBC came from Southern New England Tel (merged into SBC on Oct. 26, 1998) OR
SBC came from Ameritech (merged into SBC on Oct. 8, 1999)
Ameritech came from ATT (Divestiture—Ameritech on Jan. 1, 1984)

This relatively simple report can be very helpful for tax professionals because it provides a direction in which to look in an investor's portfolio for possible sources of the stock. Once the source of the stock has been identified, the user can then use the database again to determine the cost basis of the stock.

Estate Valuation

The present invention also may be used when determining the basis of stocks in an estate. As mentioned previously, current tax laws provide for a recipient of stock from an estate to use a new or “step-up” basis for stocks that are inherited. At present, step-up basis may be determined on two alternate dates, the first being the date of death and the second being 6 months after the date of death. The present invention may provide, however, that an alternate date may be set for a different day, such as providing that the alternate date can be set to coincide with any date permitted by law. Because alternate dates are permitted, the value of the stock may be determined as of both days and the larger of the two used as the step-up basis. As tax law changes, the database or other component of the system may be updated to reflect changes in tax law.

Currently, U.S. tax law does not permit the decedent's cost basis to be used by the recipient of the stock after death. Thus, if the cost basis of the decedent's stock is higher than the value of the stock on the date of death or on an alternate date permitted by law, the new basis applied to the stock for the recipient is stepped down to the value of the stock on one of the permitted dates. Even though currently a recipient of stock from an estate is not permitted to use the decedent's cost basis, this feature may be provided by the present invention.

In order to determine the alternate new or step-up basis values, the user identifies at least the stock or stocks of interest and the date of death. The database may then be used to determine whether any stock events have taken place between the date of death and the alternate date. Once the number of shares are known for both dates, historical information regarding the stock price on these dates may be obtained in order to determine the higher step-up basis to use.

If the decedent's stocks are in certificate form, the database also may be used to identify the name and amount of shares the decedent owned at the time of death. The same analysis can also be performed to determine the contents of the portfolio at the alternate date.

It should be noted, however, that if the changes in the law permit use of a decendent's cost basis, use of step-up basis may be optional or user selectable if the decedent's cost basis is higher than the step-up basis. Thus, the present invention may allow cost basis to be used instead of the step-up basis, particularly if relevant tax laws permit its use. Thus, in some embodiments of the invention it would be beneficial to know the decedent's cost basis in addition to the step up basis values. Using the methods already described herein, the decedent's cost basis can be readily found and compared to the step-up basis values.

Certificate Updating

The present invention also may be used when determining the status of stocks held in certificate form. Some investors may prefer to hold stock in certificate form, but over time stock events may occur that can change the value of the stock certificate and the type and number of shares the certificate represents. For example, the company may have merge with another company, thereby resulting in the original stock listed on the certificate no longer being traded. In another example, the stock listed on the certificate may undergo one or more stock splits, which would mean that the certificate that the number of shares listed on the certificate no longer represents the accurate number of shares the certificate represents.

Automatic updating of a stock certificate utilizes many of the features and parsing or searching steps described above. Information about the stock certificate is first entered into the system. Preferably, the stock name, the number of shares listed on the certificate, and the date of the certificate are provided. The database is then parsed or searched according to stock names to determine whether the stock is in the database. If it is, the event table is then parsed to determine which stock events occurred after the certificate was issued. Reports generated may then reflect the events that took place since the certificate issued and the effect on the number and type of shares that the certificate represents. Once the number and type of shares are known, current information about their value can also be included in the report. If the original basis of the shares reflected in the certificate is known, it is also possible to automatically determine the current cost basis is for each share of stocks using the steps previously described.

This feature of the invention may be useful in combination with other features of the invention. For instance, part or all of an estate valuation may include investments held in certificate form. Thus, one of the steps for performing an estate valuation may comprise updating the number and types of stocks held in certificate form.

While many embodiments of the invention have been provided above to illustrate that the invention may be used in several different ways, skilled artisans would appreciate that further changes and modifications in the specifically described embodiments can be carried out without departing from the scope of the invention.

1. A method of automatically determining the effect of stock events in a portfolio, said method comprising the steps of:
(a) providing a database of stock event information for a plurality of stocks, said stock event information comprising:
stock names;
stock share adjustment values;
stock price adjustment values;
resulting stock share multiplier values;
resulting stock price multiplier values; and
resulting stock names;
(b) selecting a stock in the portfolio;
(c) providing information about a first transaction of said stock, wherein said transactional information comprises:
the quantity of shares of said stock associated with the first transaction;
when the first transaction occurred; and
how much the first transaction cost;
(d) identifying whether said first transaction added or removed stock from the portfolio;
(e) identifying stock events related to the selected stock after said first transaction and affecting the number or types of stock in the portfolio, wherein the step of identifying related stock events comprises comparing said first transactional information to said database of stock event information; and
(f) determining the quantity and type of shares in the portfolio after the occurrence of said stock event information.

2. The method of claim 1, wherein the stock events identified affect the price or number of shares of said stock in said portfolio.

3. The method of claim 2, wherein the stock events identified comprise stock splits, reverse stock splits, mergers, or spin-offs.

4. The method of claim 1, further comprising the steps of:
(g) selecting an accounting method for accounting for the addition or removal of stock from said portfolio;
(h) automatically determining the cost basis of said stock after the occurrence of said stock event information; and
(i) generating and displaying a report of cost basis.

5. The method of claim 4, further comprising the steps of:
providing information about a second transaction of said stock, wherein said information about said second transaction comprises:
the quantity of shares of said stock associated with the second transaction;
when the second transaction occurred; and
how much the second transaction cost;
identifying whether said second transaction added or removed stock from the portfolio;
identifying stock events related to the selected stock after said second transaction and affecting the number or types of stock in the portfolio, wherein the step of identifying related stock events comprises comparing said second transactional information to said database of stock event information; and
determining the quantity and type of shares in the portfolio after the occurrence of said stock event information.

6. The method of claim 5, further comprising the step of determining the quantity of shares of said stock in the portfolio after said second transaction; and

7. The method of claim 1, wherein the step of identifying stock events after said first transaction results in more than one stock event being identified.

8. The method of claim 7, wherein the step of determining the quantity and type of shares in the portfolio after the occurrence of said stock event information is performed for each stock event for said stock after the first transaction.

9. The method of claim 8, further comprising the steps of:
(g) providing information about a second transaction of said stock;
(h) identifying stock events related to the selected stock after said second transaction;
(i) selecting an accounting method used by the investor;
(j) automatically determining the cost basis of said stock after the occurrence of said second transaction using the selected accounting method;
(k) generating and displaying a report of cost basis.

10. The method of claim 9, wherein said second transaction comprises a sale, donation, or other disposition of stock, and further comprising the step of determining gains or losses according to the selected accounting method.

11. The method of claim 4, wherein the step of generating and displaying a report of cost basis comprises:
identifying stock purchases and sales;
identifying stock events; and
identifying new stocks resulting from stock events.

12. The method of claim 1, wherein the step of providing information about when a first transaction occurred comprises an approximate date range.

13. A method of automatically updating a stock certificate comprising the steps of:
(a) providing a database of stock event information for a plurality of stocks, said stock event information comprising:
stock names;
stock share adjustment values;
stock price adjustment values;
(b) selecting a stock name from said stock certificate;
(c) providing information about the stock described on said stock certificate, wherein said information comprises:
the quantity of shares of said stock associated with the certificate;
when the certificate issued; and
how much the first transaction cost;
(d) identifying stock events related to the selected stock after when the certificate issued and affecting the number or types of stock represented by the certificate, wherein the step of identifying related stock events comprises comparing when the certificate issued to said database of stock event information; and
(e) determining the quantity and type of shares represented by the certificate after the occurrence of said stock event information.

14. The method of claim 13, wherein said database of stock event information further comprises:
resulting stock share multiplier values;
resulting stock price multiplier values; and
resulting stock names.

15. The method of claim 14, further comprising the step of generating and displaying a report of the effect of stock events on the quantity and type of shares represented by the certificate.

16. The method of claim 15, wherein said report comprises names and quantities of stocks represented by the certificate and the present value of the stocks held.

17. A method of determining possible origins of stock in a portfolio comprising the steps of:
(a) providing a database of stock event information for a plurality of stocks, said stock event information comprising:
original stock names;
original stock share adjustment values;
original stock price adjustment values;
resulting stock share multiplier values;
resulting stock price multiplier values; and
resulting stock names;
(b) selecting a first stock having a first stock name;
(c) searching the resulting stock names in the database for the first stock name;
(d) identifying a first set of original stock names related to stock event information where the first stock name matches the resulting stock name;
(e) generating and displaying a report comprising the first set of identified stock names.

18. The method of claim 17, further comprising the steps of:
(f) searching the resulting stock names in the database for stock names from the first set of identified stock names;
(g) identifying a second set of original stock names related to stock event information where at least one stock name from the first set of identified stock names matches the resulting stock name;
(h) wherein the step of generating and displaying a report further comprises the second set of identified stock names.

19. A method of automating estate valuation comprising the steps of:
(a) providing a database of stock event information for a plurality of stocks, said stock event information comprising:
original stock names;
original stock share adjustment values;
original stock price adjustment values;
resulting stock share multiplier values;
resulting stock price multiplier values; and
resulting stock names;
(b) entering known information about a first stock in a decedent's portfolio;
(c) automatically identifying a first set of stock events related to the first stock that affected the number or types of stock in the decedent's portfolio before the decedent's death;
(d) automatically determining the quantity and type of shares in the portfolio after the occurrence of said first set of stock event information;
(e) determining the value of the portfolio as of the day of the decedent's death;
(f) automatically identifying a second set of stock events related to the first stock that affected the number or types of stock in the decedent's portfolio before an alternate date after the decedent's death;
(g) determining the value of the portfolio as of the alternate date; and
(i) selecting a new basis from the decedent's cost basis, the value of the portfolio as of the day of the decedent's death, or the value of the portfolio as of the alternate date.

20. The method of claim 19, wherein the alternate date is approximately 6 months after the decedent's death.

21. The method of claim 19, wherein the alternate date corresponds to a date permitted by tax law.

22. The method of claim 19, wherein the step of selecting a new basis comprises selecting the highest value from the decedent's cost basis, the value of the portfolio as of the day of the decedent's death, or the value of the portfolio as of the alternate date.
